(19) United States
(12) Patent Application Publication
(10) Pub. No.: US 2022/0019631 A1
(43) Pub. Date: Jan. 20, 2022

(54) SYSTEM AND METHOD FOR ANIMATED WEBSITE

(71) Applicant: Fox Sports Productions, LLC, Los Angeles, CA (US)

(72) Inventor: David Katz, Los Angeles, CA (US)

(21) Appl. No.: 17/376,836

(22) Filed: Jul. 15, 2021

Related U.S. Application Data
(60) Provisional application No. 63/052,792, filed on Jul. 16, 2020.

(51) Int. Cl. G06F 16/958; H04L 29/06; G06F 3/0485; G06F 3/0488

(52) U.S. Cl. CPC G06F 16/958; H04L 65/4076; G06F 3/04883; G06F 3/0485; H04L 65/4084

(57) ABSTRACT

An animated website is described that provides a seamless, user friendly website experience with regard to event media feeds, story or article tiles, and other supporting media and content.

This application claims the benefit of priority to U.S. Provisional Application No. 63/052,792 filed Jul. 16, 2020, the disclosure of which is incorporated herein by reference in its entirety.

### FIELD

The present technology is generally related to an animated website, presenting articles and media in a seamless, user friendly manner.

### BACKGROUND

Traditional websites, particularly those that present articles and plural media, can be somewhat static, requiring multiple navigation steps to access articles and media.

What is needed in the art are additional options presenting a less disjointed website experience.

### SUMMARY

The techniques of this disclosure generally relate to an animated website that avoids the problems and disadvantages in the prior art by providing a seamless, user friendly website experience.

In one exemplary aspect, the present disclosure provides such experience in the context of moving story or article tiles, responsive to swipes or scrolls to browse between a series of stories or articles to open supplemental tiles with further information, media, etc.

In additional exemplary aspects, the graphic user interface (GUI) slides directly from the bottom of a scrolled story or article into another article or into another page of information.

In another exemplary aspect, the disclosure provides a GUI with a Live TV window and one or more bonus feeds providing video at the same time as the Live TV window, such that plural media windows that play concurrently. In further exemplary aspects, audio may be switched off of the Live TV feed to a bonus feed as desired. In further exemplary aspects, the relative sizes of the Live TV feed and the bonus feed(s) may be adjusted by a swiping or scrolling gesture.

In additional exemplary aspects, the disclosure provides a GUI with automatically configured options for pre-game, Live TV and post-game browsing of media and content. In further exemplary embodiments, story tiles, articles, supplemental content, or other content may comprise or include (e.g., as embedded content) functionalized content, such as betting or odds content (with in exemplary embodiments actual betting function(s) being disabled in areas or states that do not allow such activity).

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a front elevation view of an exemplary mobile computing device GUI in accordance with embodiments of the disclosure;

FIG. 2 is another front elevation view of an exemplary mobile computing device GUI in accordance with embodiments of the disclosure;

FIG. 3 is another front elevation view of an exemplary mobile computing device GUI in accordance with embodiments of the disclosure;

FIG. 4 is another front elevation view of an exemplary mobile computing device GUI in accordance with embodiments of the disclosure;

FIG. 5 is another front elevation view of an exemplary mobile computing device GUI in accordance with embodiments of the disclosure;

FIG. 6 is another front elevation view of an exemplary mobile computing device GUI in accordance with embodiments of the disclosure;

FIG. 7 is another front elevation view of an exemplary mobile computing device GUI in accordance with embodiments of the disclosure;

FIG. 8 is another front elevation view of an exemplary mobile computing device GUI in accordance with embodiments of the disclosure;

FIG. 9 is another front elevation view of an exemplary mobile computing device GUI in accordance with embodiments of the disclosure;

FIG. 10 is another front elevation view of an exemplary mobile computing device GUI in accordance with embodiments of the disclosure;

FIG. 11 is another front elevation view of an exemplary mobile computing device GUI in accordance with embodiments of the disclosure;

FIG. 12 is another front elevation view of an exemplary mobile computing device GUI in accordance with embodiments of the disclosure;

FIG. 13 is another front elevation view of an exemplary mobile computing device GUI in accordance with embodiments of the disclosure;

FIG. 14 is another front elevation view of an exemplary mobile computing device GUI in accordance with embodiments of the disclosure;

FIG. 15 is another front elevation view of an exemplary mobile computing device GUI in accordance with embodiments of the disclosure;

FIG. 16 is another front elevation view of an exemplary mobile computing device GUI in accordance with embodiments of the disclosure;

FIG. 17 is another front elevation view of an exemplary mobile computing device GUI in accordance with embodiments of the disclosure;

FIG. 18 is another front elevation view of an exemplary mobile computing device GUI in accordance with embodiments of the disclosure;

FIG. 19 is another front elevation view of an exemplary mobile computing device GUI in accordance with embodiments of the disclosure;

FIG. 20 is another front elevation view of an exemplary mobile computing device GUI in accordance with embodiments of the disclosure;

FIG. 21 is another front elevation view of an exemplary mobile computing device GUI in accordance with embodiments of the disclosure;

FIG. 22 is another front elevation view of an exemplary mobile computing device GUI in accordance with embodiments of the disclosure;

FIG. 23 is another front elevation view of an exemplary mobile computing device GUI in accordance with embodiments of the disclosure;

FIG. 24 is another front elevation view of an exemplary mobile computing device GUI in accordance with embodiments of the disclosure;

FIG. 25 is another front elevation view of an exemplary mobile computing device GUI in accordance with embodiments of the disclosure;

FIG. 26 is another front elevation view of an exemplary mobile computing device GUI in accordance with embodiments of the disclosure;

FIG. 27 is another front elevation view of an exemplary mobile computing device GUI in accordance with embodiments of the disclosure;

FIG. 28 is another front elevation view of an exemplary mobile computing device GUI in accordance with embodiments of the disclosure;

FIG. 29 is another front elevation view of an exemplary mobile computing device GUI in accordance with embodiments of the disclosure;

FIG. 30 is another front elevation view of an exemplary mobile computing device GUI in accordance with embodiments of the disclosure;

FIG. 31 is another front elevation view of an exemplary mobile computing device GUI in accordance with embodiments of the disclosure;

FIG. 32 is another front elevation view of an exemplary mobile computing device GUI in accordance with embodiments of the disclosure;

FIG. 33 is another front elevation view of an exemplary mobile computing device GUI in accordance with embodiments of the disclosure;

FIG. 34 is another front elevation view of an exemplary mobile computing device GUI in accordance with embodiments of the disclosure;

FIG. 35 is another front elevation view of an exemplary mobile computing device GUI in accordance with embodiments of the disclosure;

FIG. 36 is another front elevation view of an exemplary mobile computing device GUI in accordance with embodiments of the disclosure;

FIG. 37 is another front elevation view of an exemplary computing device GUI in accordance with embodiments of the disclosure;

FIG. 38 is another front elevation view of an exemplary computing device GUI in accordance with embodiments of the disclosure;

FIG. 39 is another front elevation view of an exemplary computing device GUI in accordance with embodiments of the disclosure;

FIG. 40 is another front elevation view of an exemplary computing device GUI in accordance with embodiments of the disclosure;

FIG. 41 is another front elevation view of an exemplary computing device GUI in accordance with embodiments of the disclosure;

FIG. 42 is another front elevation view of an exemplary computing device GUI in accordance with embodiments of the disclosure;

FIG. 43 is another front elevation view of an exemplary computing device GUI in accordance with embodiments of the disclosure;

FIG. 44 is another front elevation view of an exemplary computing device GUI in accordance with embodiments of the disclosure;

FIG. 45 is another front elevation view of an exemplary computing device GUI in accordance with embodiments of the disclosure;

FIG. 46 is another front elevation view of an exemplary computing device GUI in accordance with embodiments of the disclosure;

FIG. 47 is another front elevation view of an exemplary computing device GUI in accordance with embodiments of the disclosure;

FIG. 48 is another front elevation view of an exemplary computing device GUI in accordance with embodiments of the disclosure;

FIG. 49 is another front elevation view of an exemplary computing device GUI in accordance with embodiments of the disclosure;

FIG. 50 is another front elevation view of an exemplary computing device GUI in accordance with embodiments of the disclosure;

FIG. 51 is another front elevation view of an exemplary computing device GUI in accordance with embodiments of the disclosure;

FIG. 52 is another front elevation view of an exemplary computing device GUI in accordance with embodiments of the disclosure;

FIG. 53 is another front elevation view of an exemplary computing device GUI in accordance with embodiments of the disclosure;

FIG. 54 is another front elevation view of an exemplary computing device GUI in accordance with embodiments of the disclosure;

FIG. 55(a)-(e) illustrates a series of exemplary computing device GUIs in accordance with embodiments of the disclosure;

FIG. 56(a)-(e) illustrates a series of exemplary computing device GUIs in accordance with embodiments of the disclosure;

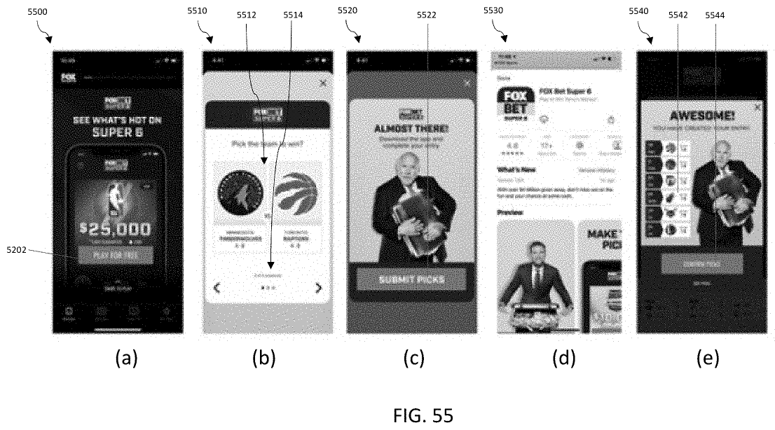

FIG. 55(a)-(b) illustrates a series of exemplary computing device GUIs in accordance with embodiments of the disclosure; and

FIG. 58(a)-(c) illustrates a series of exemplary computing device GUIs in accordance with embodiments of the disclosure.

### DETAILED DESCRIPTION

In the present disclosure, for convenience, the terms swipe and scroll are used alternatively, regardless of input (e.g., finger or mouse, mouse wheel, touch pad, eye or gaze recognition, etc.). It should be recognized that even mobile devices designed primarily for finger swiping could be docked and controlled by another input device. Alternatively, traditional desktop devices, etc., can also be controlled by a variety of input devices, from keyboards to touch sensitive devices.

Additionally, the below uses the word tile, which is meant to be non-limiting. We note that such reference is made to a series of stories or other components that may be moved across the GUI, may partially cover or obscure another component or tile, etc.

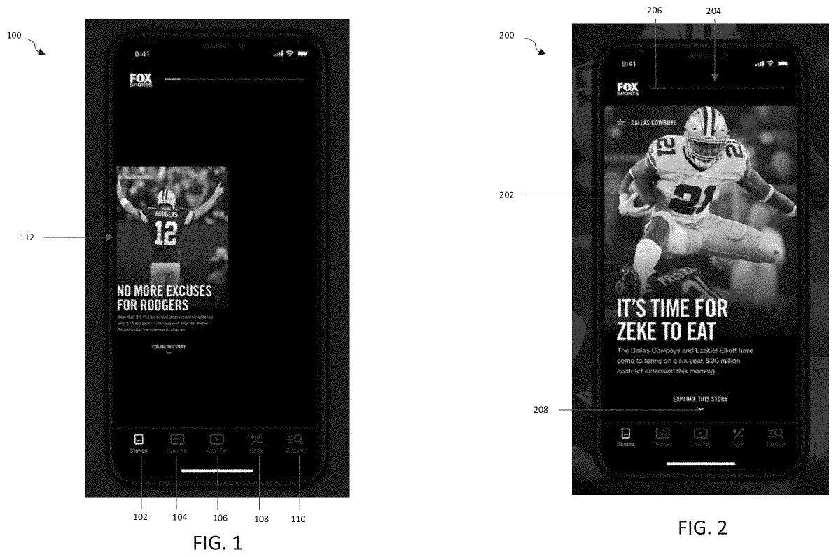

Referring now to FIG. 1, an exemplary mobile computing device GUI is illustrated generally at 100. Exemplary categorical menu items for the GUI include: Stories 102; Scores 104; Live television (TV) 106; Odds 108; and Explore 110. In exemplary embodiments, upon selection of Stories 102 or in addition to/alternately upon opening the GUI/application, a plurality of stories or articles populates the GUI. In exemplary embodiments, the plurality of stories is provided as an animation including a series that enters the GUI from the left side and expands into a slidable or scrollable series of tiles.

FIG. 2 illustrates another exemplary mobile computing device GUI generally at 200, showing the expanded first tile 202 in a series of story tiles. The first tile is also represented by the first bar 206 of a plurality of bars, represented as a hashed line visual indicator, shown generally at 204, and indicating different tiles in a series. A directional indicator 208 indicates that the contents of the story presented on the tile may be further explored by movement in the direction of the arrow (in this case down).

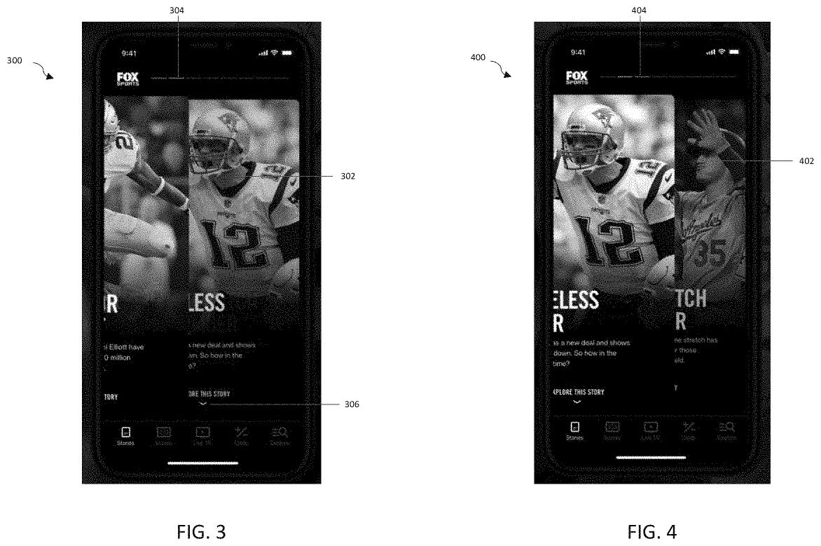

FIG. 3 illustrates another exemplary mobile computing device GUI generally at 300, showing a left swipe of the tiles and corresponding animated scrolling of tiles to the left, with the second story/tile 302 expanding into place from behind and being exposed by the movement of the first tile. The second bar 304 of the plurality of bars is highlighted during the movement. The second tile also includes a directional indicator 306 for exploring the story.

FIG. 4 illustrates another exemplary mobile computing device GUI generally at 400, showing a left swipe of the tiles and corresponding animated scrolling of tiles to the left, with the third story/tile 402 expanding into place from behind, increasing another aspect of the tile image (e.g., brightness) and being exposed by the movement of the first tile. As the tile is only partly exposed, the third bar 404 of the plurality of bars is partly highlighted during this movement. The third tile also includes a directional indicator for exploring the story, but it is not yet visible in FIG. 4.

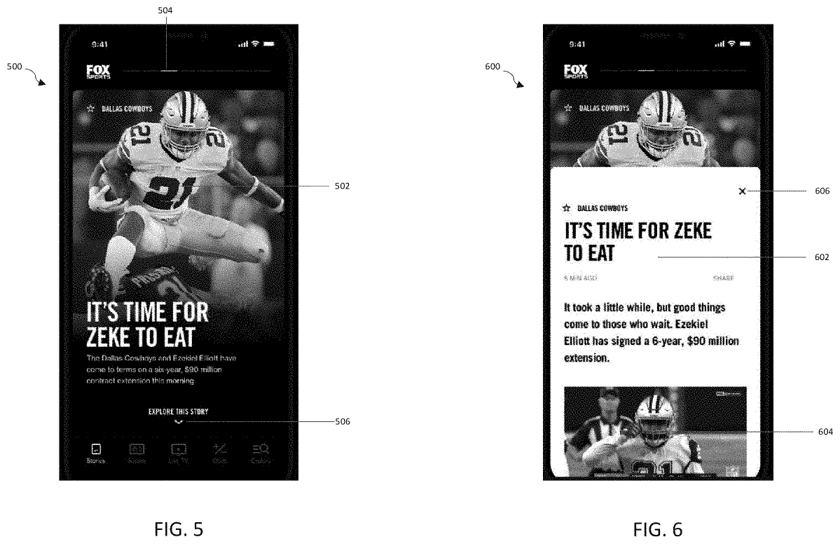

FIG. 5 illustrates another exemplary mobile computing device GUI generally at 500, showing the third story/tile 502 fully in place (note that the third bar 504 of the plurality of bars is also fully highlighted). The third tile directional indicator 506 for exploring the story is also visible in FIG. 5.

FIG. 6 illustrates another exemplary mobile computing device GUI generally at 600, showing activation of the directional indicator 506 from FIG. 5, with corresponding raising of a supplemental tile 602 providing further information relating to the story. The supplemental tile is overlaid on the third tile. Supplemental medial content 604 may also be included in the supplemental tile 602, as well as opinion, statistics, social media, or any other information. An exit icon 606 is also included for the supplemental tile.

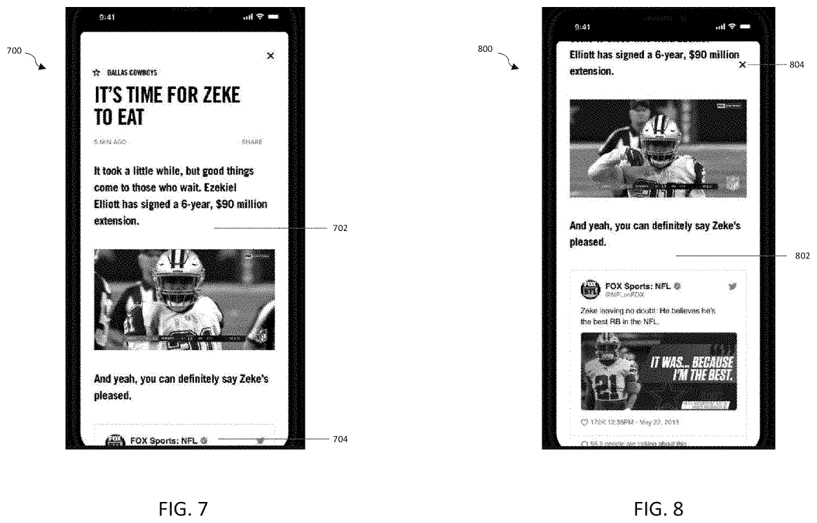

FIG. 7 illustrates another exemplary mobile computing device GUI generally at 700, showing further upward scrolling of supplemental tile 702, which now obscures the third tile. Social medial content 704 is also visible in the supplemental tile.

FIG. 8 illustrates another exemplary mobile computing device GUI generally at 800, showing additional upward scrolling of supplemental tile 802 beyond that in FIG. 7. An exit icon 804 remains in position during this additional upward scrolling (such that content disappears off of the top of the GUI display.

FIG. 8 illustrates another exemplary mobile computing device GUI generally at 800, showing additional upward scrolling of supplemental tile 802 beyond that in FIG. 7. An exit icon 804 remains in position during this additional upward scrolling (such that content disappears off of the top of the GUI display).

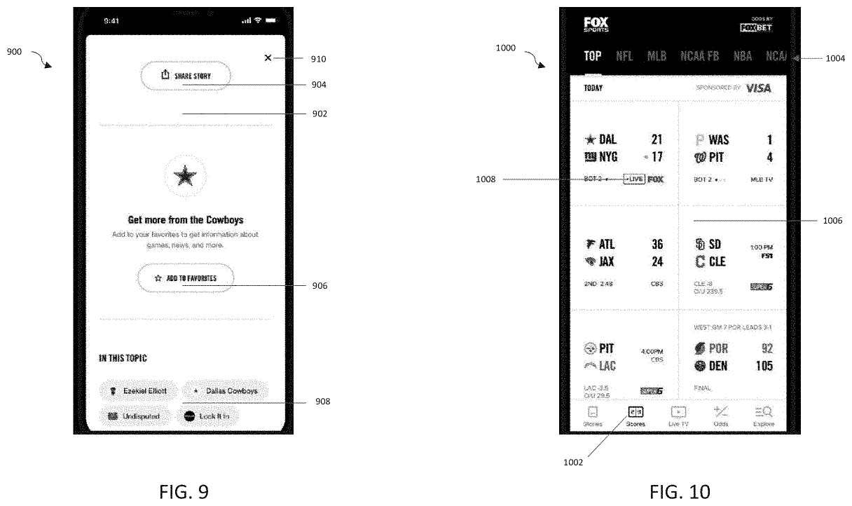

FIG. 9 illustrates another exemplary mobile computing device GUI generally at 900, showing a bottom portion of supplemental tile 902 beyond that in FIG. 8. A sharing action button 904 allows sharing of the story to contacts, users, social media, etc. A favorites action button 906 allows addition of related categories (e.g., the subject team) to a profile favorites to allow the user to get further or ongoing information about that category. One or more topical items are also presented as selectable buttons 908 to facilitate searching. In exemplary embodiments, the user may either select exit icon 910 to close the supplemental tile, or further swiping can dismiss the tile, bringing back the GUI display of FIG. 5.

FIG. 10 illustrates another exemplary mobile computing device GUI generally at 1000, showing selection of the Scores icon 1002 (icon 104 in FIG. 1). Various categories of scores may be displayed in a scrollable menu, shown generally at 1004, including: Top scores, NFL scores, MLB scores, NCAA Football scores, NBA scores, NCAA Basketball, NHL, Soccer, Golf, Boxing, NASCAR, UFC, etc. Various scores, game times, networks, etc., may be displayed in score display area 1006. Scrolling down in the score display area 1006 also can reveal further information, such as additional scores, additional game times, rankings, games for additional dates, etc.

Additionally, Live Broadcast indicators 1008 may be included, where applicable. As will be seen further below, selection, hovering over, etc., of a score can trigger media content within that score, e.g., selection of a live game can trigger display of that game behind the score and/or move the GUI into a Live Game category.

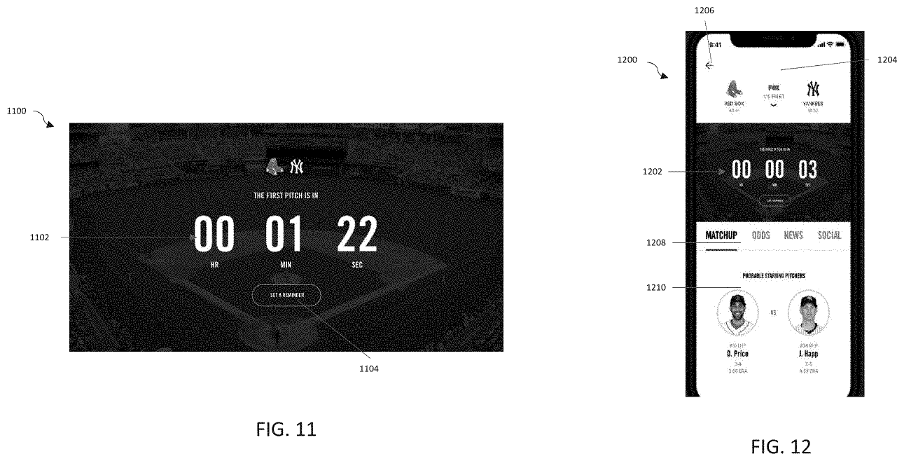

FIG. 11 illustrates another exemplary mobile computing device GUI generally at 1100, showing a full screen view of a countdown/Live TV section (shown generally at 1102) for an event (e.g., a first pitch in MLB, shown in hours, minutes and seconds). This screen is accessible via the Live TV icon 106 in FIG. 1. A reminders button 1104 allows the user to set a reminder/notification. In exemplary embodiments, this full screen horizontal mode is provided as a seamless transition between vertical and horizontal modes, e.g., between the vertical mode of FIG. 12 and the horizontal mode of FIG. 11, wherein rotation of the screen automatically expands the live (or other featured) feed at or near the top of the screen to a full screen representation (compare the countdown screens between FIG. 12 and FIG. 11. In further exemplary embodiments, rotation of the mobile device back to vertical results in a similar, but minimized live (or featured) screen as in FIG. 12. In exemplary embodiments, this is accomplished by automatic recognition (e.g., via accelerometer or other mechanism) of screen orientation.

FIG. 12 illustrates another exemplary mobile computing device GUI generally at 1200, showing a smaller countdown/Live TV section 1202 (see full screen countdown 1102 in FIG. 11). An indication of the selected game, teams, network, game time, etc., is provided in game space 1204, inclusive of arrow back icon 1206 to exit out of a particular game page. A selectable category bar 1208 for the game page includes: Matchup; Odds; News; and Social. The illustrated selected Matchup category space 1210 shows possible starting pitchers for the game, along with statistical information.

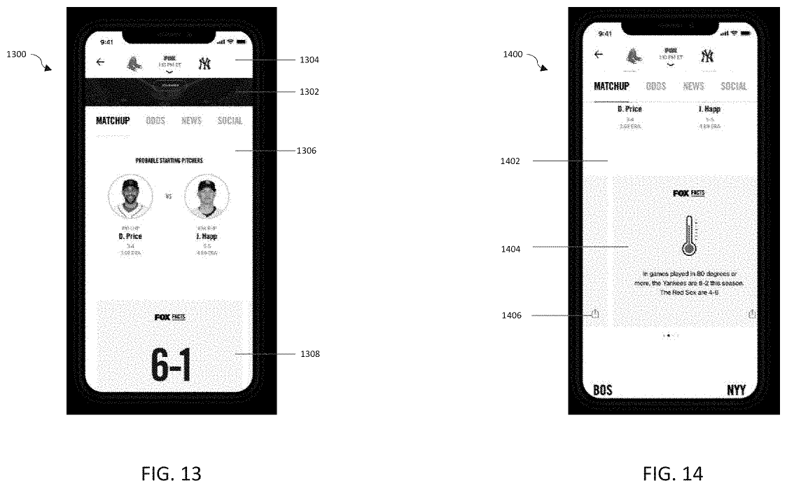

FIG. 13 illustrates another exemplary mobile computing device GUI generally at 1300, showing reduced countdown/Live TV section 1302 and game space sections 1304 (providing more room to display the additional Matchup information illustrated when the Matchup category space 1306 is swiped up). Lower, additional Matchup category space information is revealed at 1308 when accessed by scrolling the screen.

FIG. 14 illustrates another exemplary mobile computing device GUI generally at 1400, showing additional Matchup category space information 1402 as left/right swipe-able tiles 1404, including share icons 1406.

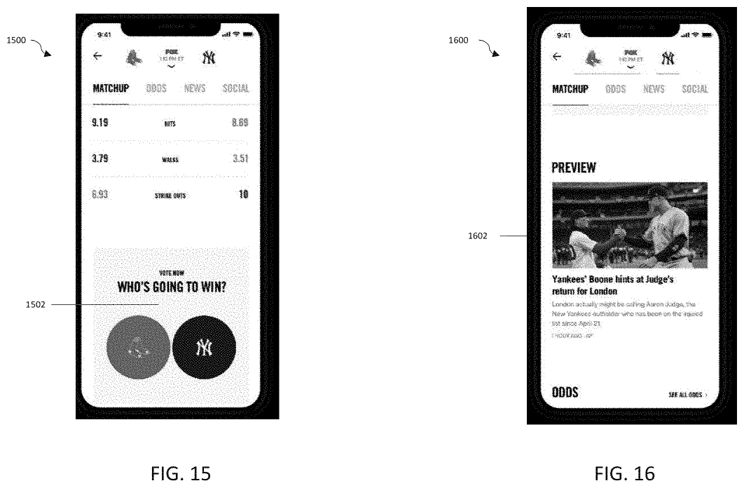

FIG. 15 illustrates another exemplary mobile computing device GUI generally at 1500, showing additional Matchup category space information as a voting section 1502, calling on user input to predict a win.

FIG. 16 illustrates another exemplary mobile computing device GUI generally at 1600, showing additional Matchup category space information as preview section 1602, including additional media and/or article information.

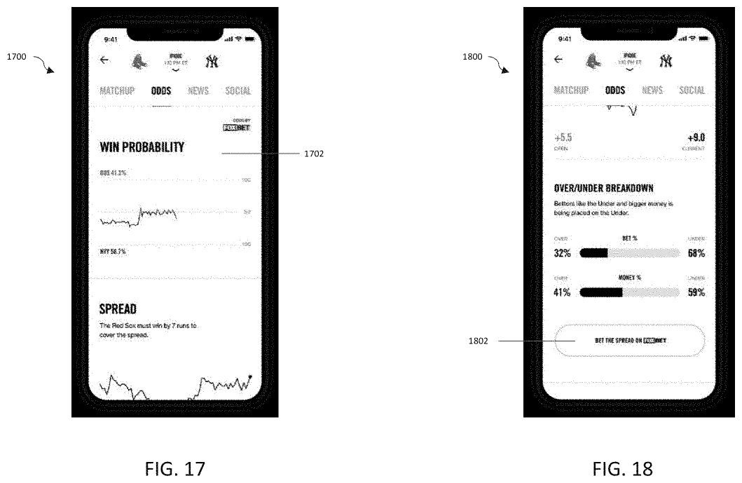

FIG. 17 illustrates another exemplary mobile computing device GUI generally at 1700, showing an Odds category space 1702, including win probabilities, spreads, etc.

FIG. 18 illustrates another exemplary mobile computing device GUI generally at 1800, showing an Odds category information including a selectable betting button 1802 (in this case linking to a betting site).

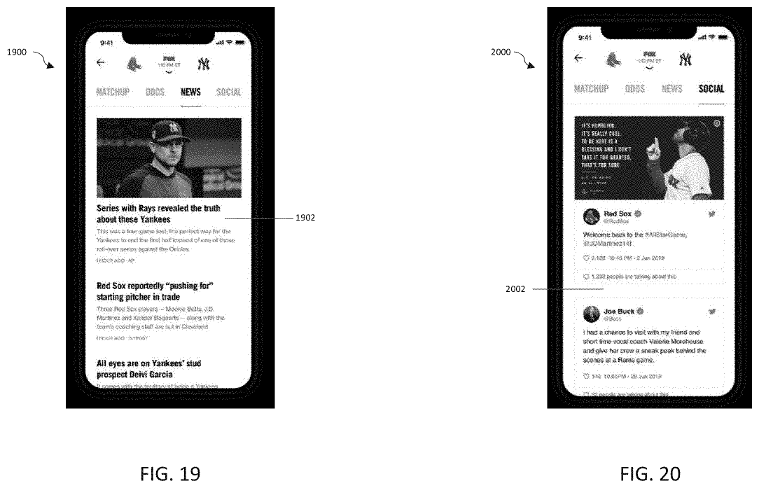

FIG. 19 illustrates another exemplary mobile computing device GUI generally at 1900, showing a News category space 1902, including news, media, etc.

FIG. 20 illustrates another exemplary mobile computing device GUI generally at 2000, showing a Social category space 2002, including social media posts, media, etc.

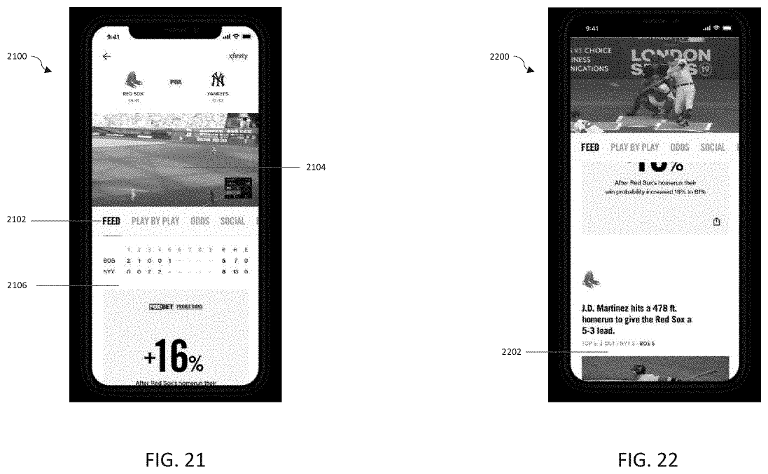

FIG. 21 illustrates another exemplary mobile computing device GUI generally at 2100, showing a selectable Feed category 2102 beneath the Live TV section 2104 (in exemplary embodiments, this category appears when a Live TV feed begins) and a Feed category space 2106, including active game feed information.

FIG. 22 illustrates another exemplary mobile computing device GUI generally at 2200, showing additional, scrollable Feed category information 2202, including media, social media, articles, etc.

FIG. 23 illustrates another exemplary mobile computing device GUI generally at 2300, showing a selectable Play By Play category 2302 beneath the Live TV section 2304 (in exemplary embodiments, this category appears when a Live TV feed begins) and a Play By Play category space 2306, including active game information.

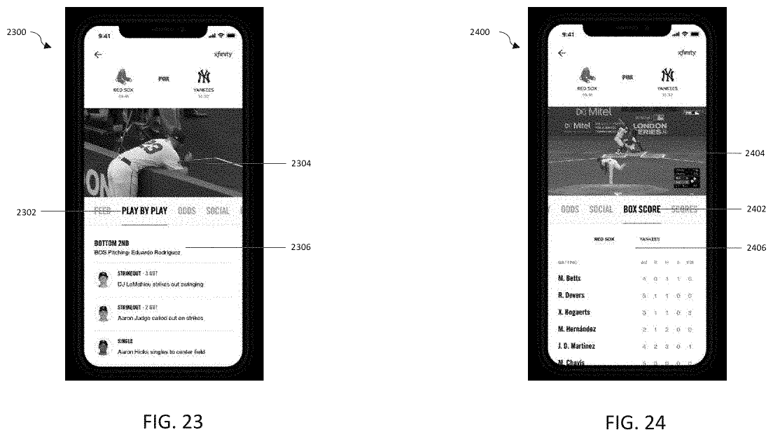

FIG. 24 illustrates another exemplary mobile computing device GUI generally at 2400, showing a selectable Box Score category 2402 beneath the Live TV section 2404 (in exemplary embodiments, this category appears when a Live TV feed begins) and a Box Score category space 2406, including active Box Score information.

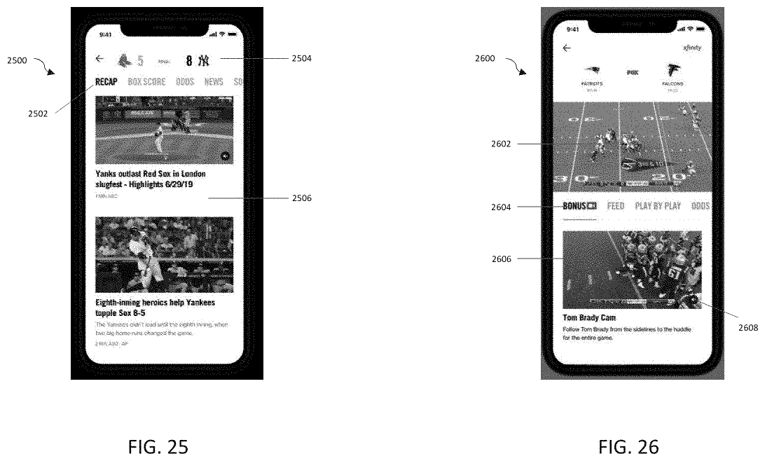

FIG. 25 illustrates another exemplary mobile computing device GUI generally at 2500, showing a selectable Recap category 2502 beneath the game space section 2504 (in exemplary embodiments, this category appears when a game ends) and a Recap category space 2506, including highlights, media, articles, or other information.

FIG. 26 illustrates another exemplary mobile computing device GUI generally at 2600, showing a selectable Bonus/Bonus Camera category 2602 beneath the Live TV section 2604 (in exemplary embodiments, this category appears when a Live TV feed begins) and a Bonus/Bonus Camera category space 2606, including one or more bonus features related to the active game (in this case, a bonus camera focused on a player).

In exemplary embodiments, the Bonus/Bonus Camera category space 2606 includes at least one bonus camera that plays concurrently with the Live TV section 2604. In further exemplary embodiments, the bonus camera plays when it is wholly within the display window of the Bonus/Bonus Camera category space 2606. In other exemplary embodiments, the bonus camera plays when it is only partially within the display window of the Bonus/Bonus Camera category space 2606, for example during a scrolling action of the space 2606. In exemplary embodiments, in such illustrated vertical (or non-horizontal) orientation, multiple videos can be played at once, at the same time.

In further exemplary embodiments, the audio of the Live TV section 2604 is maintained for audio output even when bonus camera(s) are playing. In exemplary embodiments, a bonus camera can be output with or instead of the Live TV section audio upon activation of the unmute icon 2608 on any given bonus (or other) camera or video. In exemplary embodiments, clicking on any given unmute icon of a feed or video unmutes the sound for that particular media and seamlessly and automatically mutes the sound of all other feeds or videos (though as above, those feeds or videos may still be playing).

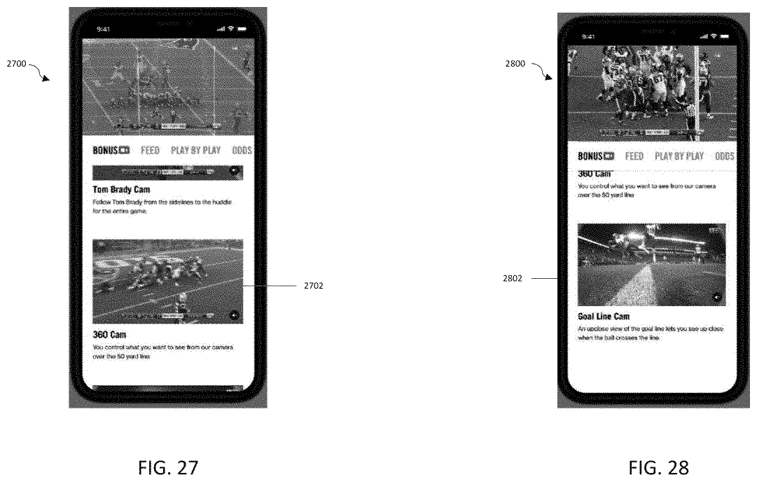

FIG. 27 illustrates another exemplary mobile computing device GUI generally at 2700, showing an exemplary bonus 360 cam 2702, which allows the user to control (e.g., via finger scroll of the image direction/perspective of cam 2702) what the user wants to see from the 360 degree camera.

FIG. 28 illustrates another exemplary mobile computing device GUI generally at 2800, showing an exemplary bonus goal line camera 2802, which provides an up-close view of the goal line when the ball crosses the line.

FIG. 29 illustrates another exemplary mobile computing device GUI generally at 2900, showing an exemplary Live TV feed 2902, with Restart/Rewind 2904 and Live/Forward 2906 controls, as well as Bonus camera control 2908, allowing selection, in this case, between three bonus cameras, as indicated by the “3” next to the camera icon. In exemplary embodiments, the camera icon may be a flashing icon that appears if and/or when additional cameras are available. In further exemplary embodiments, clicking or pressing of that icon spawns a side module that allows viewing of two (or more) cameras side by side.

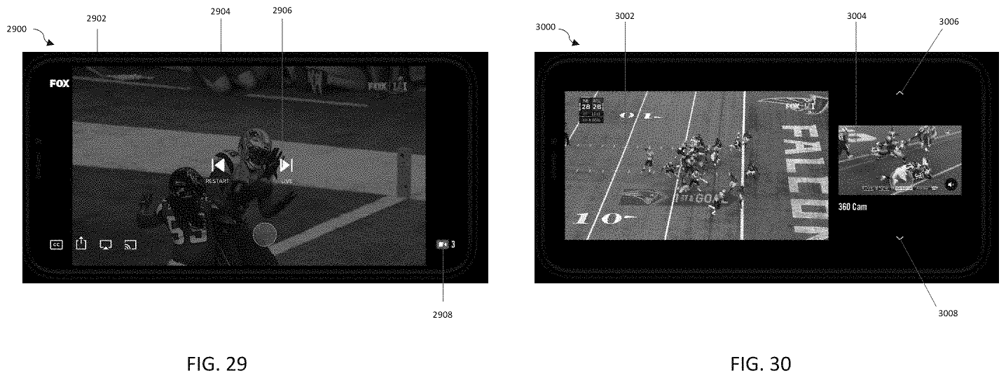

FIG. 30 illustrates another exemplary mobile computing device GUI generally at 3000, showing an exemplary Live TV feed 3002, with a bonus 360 cam 3004 and up 3006 and down 3008 directional indicators for selection of different Bonus cameras.

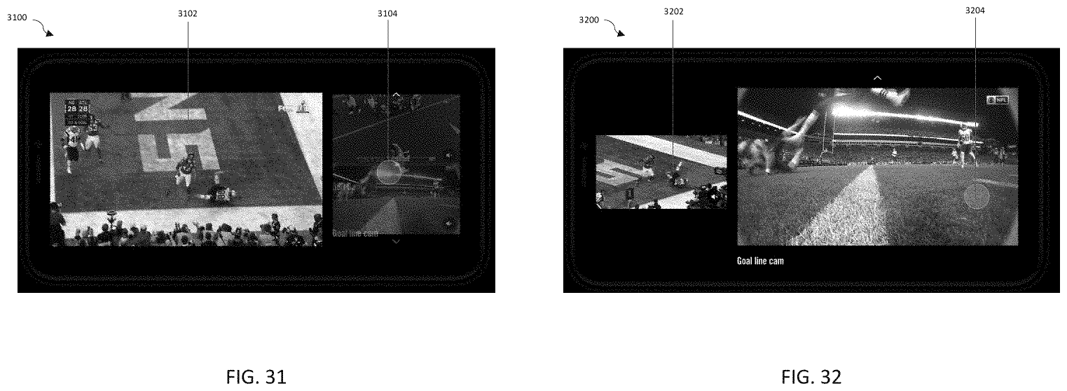

FIG. 31 illustrates another exemplary mobile computing device GUI generally at 3100, showing an exemplary Live TV feed 3102, with exemplary scrolling (e.g., finger scrolling), shown at 3104 between two bonus cameras.

FIG. 32 illustrates another exemplary mobile computing device GUI generally at 3200, showing an exemplary Live TV feed 3202, with exemplary resizing scrolling (e.g., finger resizing), shown at 3104 of a Bonus (goal line) camera to be larger than the Live TV feed.

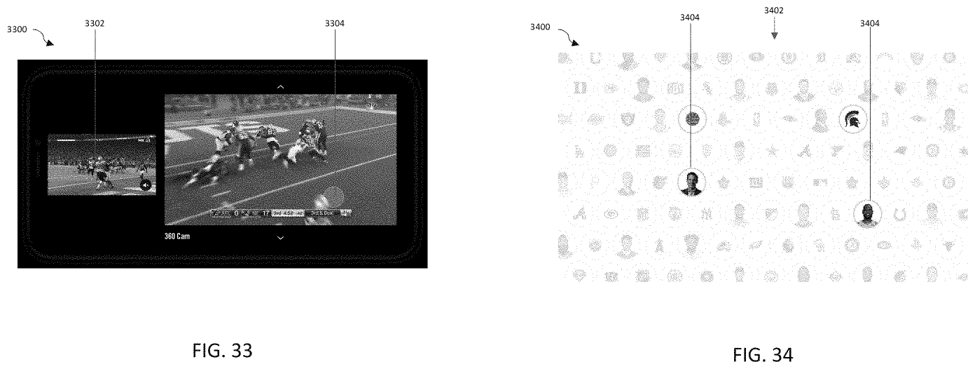

FIG. 33 illustrates another exemplary mobile computing device GUI generally at 3300, showing an exemplary Live TV feed 3302, with exemplary scrolling (e.g., finger scrolling), shown at 3304 between two bonus cameras that are sized to be larger than the Live TV feed 3302, as in FIG. 32.

FIG. 34 illustrates another exemplary mobile computing device GUI generally at 3400, showing a display showing (generally at 3402) an assortment of different possible favorites, e.g., teams, players, etc., with positive selections 3404 visually distinguished (e.g., not being at least partially faded).

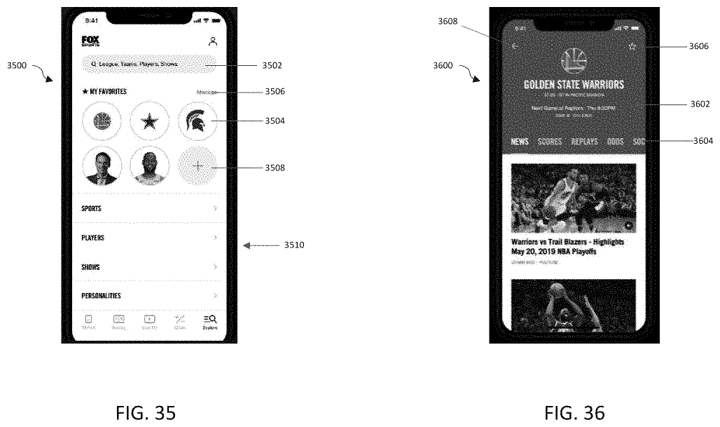

FIG. 35 illustrates another exemplary mobile computing device GUI generally at 3500, showing a My Favorites page that includes a search bar 3502, current favorites 3504, a Manage favorites icon 3506, an add button 3508, and categorical browse tabs, shown generally at 3510, e.g., by sports, players, shows, personalities, etc. FIGS. 34 and 35, as well as other possible GUI interfaces, can provide a personalized experience by offering suggestions for the user based on assessed or estimated preferences, aggregated news or other information that may be of interest to the user, abbreviated story hubs that are personalized, etc.

FIG. 36 illustrates another exemplary mobile computing device GUI generally at 3600, showing a team page 3602, with a scrollable information bar 3604, e.g., with populated categories for News, Scores, Replays, Odds, Social Media, Standings, Roster, etc. A favorites select/deselect icon 3606 is also provided, along with a browse back arrow 3608.

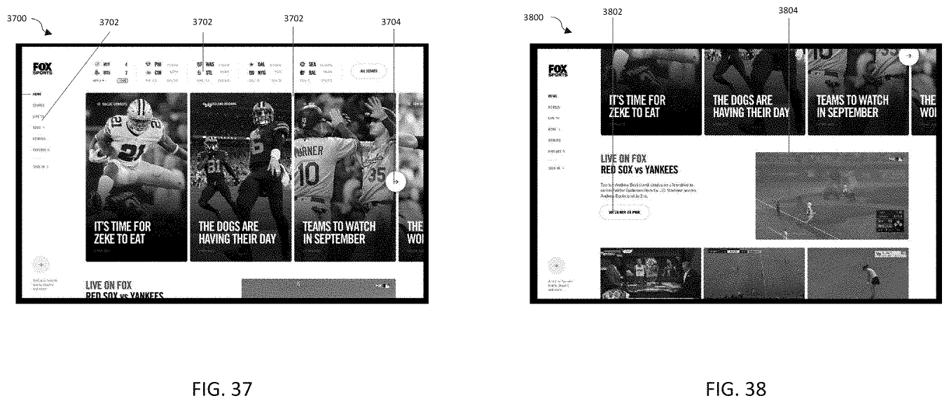

FIG. 37 illustrates an exemplary computing device GUI generally at 3700, showing plural story tiles 3702 with a navigational arrow 3704, a scores section 3706 and an overall menu 3708.

FIG. 38 illustrates another exemplary computing device GUI generally at 3800, with a watch live button 3802 and with additional media content 3804.

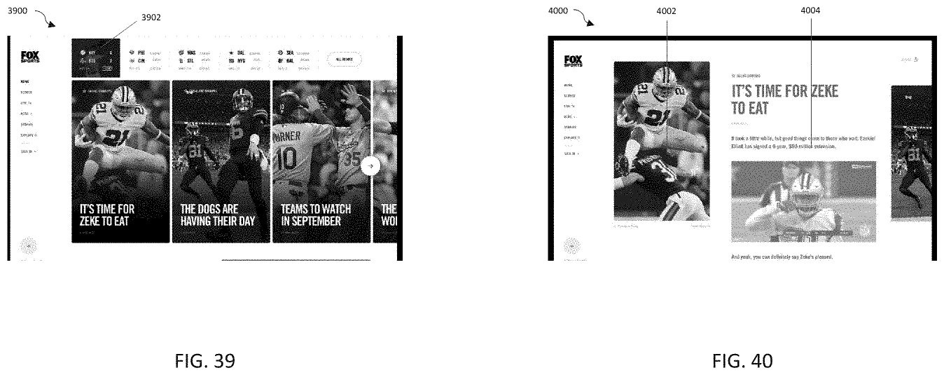

FIG. 39 illustrates another exemplary computing device GUI generally at 3900, illustrating a score highlight (e.g., holding a mouse cursor above the score) 3902, with background media playing in the same area. In exemplary embodiments using background media, such media may be current media (e.g., current media clipped to contain the last 30 seconds of the live feed (or other media)).

FIG. 40 illustrates another exemplary computing device GUI generally at 4000, illustrating the opening of a first story tile 4002, beginning to reveal article contents 4004 (note that the article contents are partially grayed out since the article has not yet fully opened).

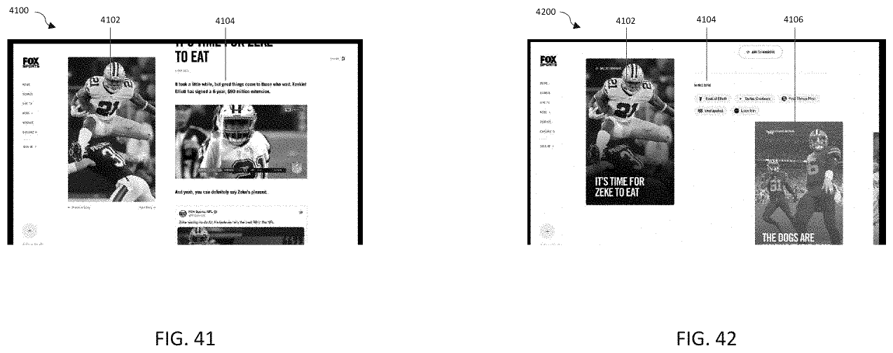

FIG. 41 illustrates another exemplary computing device GUI generally at 4100, illustrating the opening of a first story tile 4102, fully revealing article contents 4104.

FIG. 42 illustrates another exemplary computing device GUI generally at 4200, illustrating the closing of article contents 4204 of a first story tile 4202 (note that additional story tiles 4206 are collapsing back into line with the first story tile 4202 and are partially grayed out). In exemplary embodiments, this action occurs automatically upon scrolling to the end of article contents 4004, providing a seamless article browsing experience.

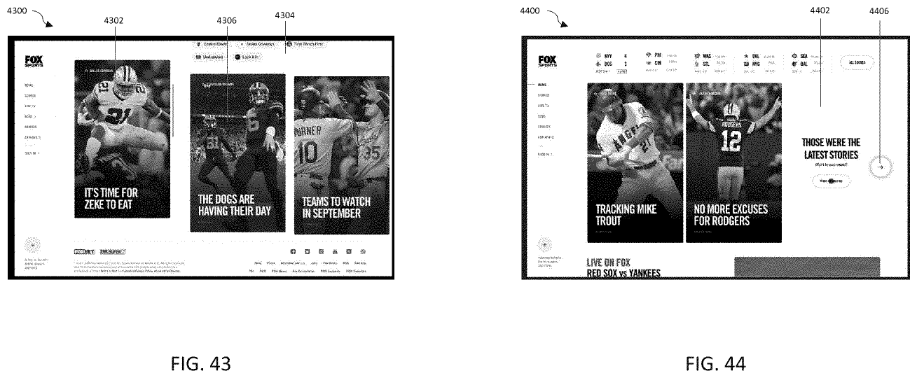

FIG. 43 illustrates another exemplary computing device GUI generally at 4300, illustrating almost complete closing of article contents 4304 of a first story tile 4302, with the additional story tiles 4306 almost back into line with the first story tile 4302.

FIG. 44 illustrates another exemplary computing device GUI generally at 4400, illustrating an indication of an end of story tiles 4402 and providing a directional arrow for additional stories 4406.

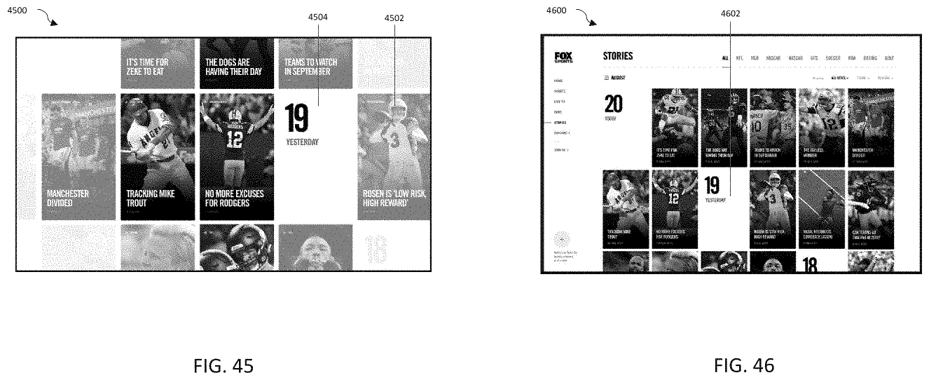

FIG. 45 illustrates another exemplary computing device GUI generally at 4500, illustrating an activation of directional arrow from FIG. 44, with additional stories 4502 according to date 4504 beginning to populate the screen dynamically, drawing in from the edges and becoming less grayed out.

FIG. 46 illustrates another exemplary computing device GUI generally at 4600, plural articles fully populated according to date 4602.

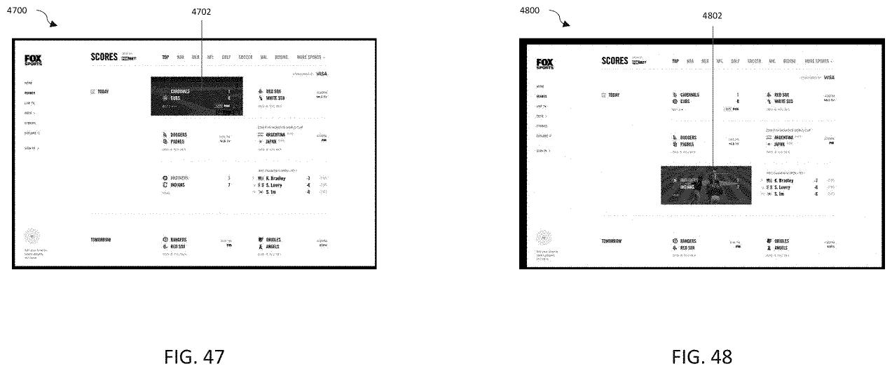

FIG. 47 illustrates another exemplary computing device GUI generally at 4700, illustrating a score highlight (e.g., holding a mouse cursor above the score) 4702, with background media playing in the same area.

FIG. 48 illustrates another exemplary computing device GUI generally at 4800, illustrating another score highlight (e.g., holding a mouse cursor above the score) 4802, with background media playing in the same area.

FIG. 49 illustrates another exemplary computing device GUI generally at 4900, illustrating a game play feed 4902.

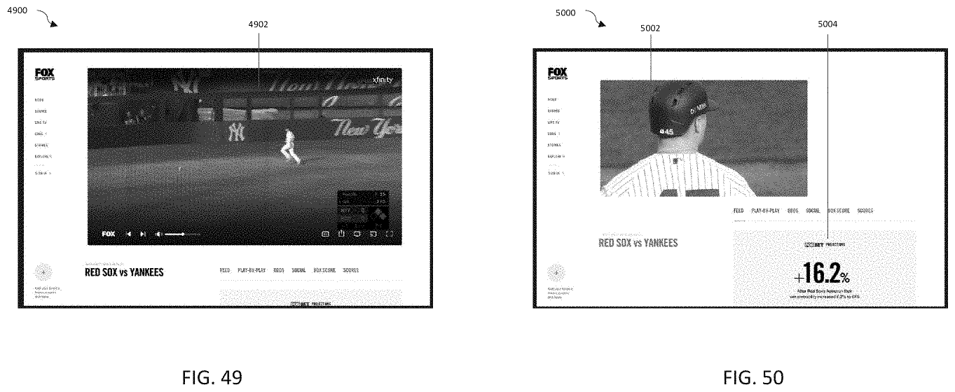

FIG. 50 illustrates another exemplary computing device GUI generally at 5000, illustrating transition to a reduced size game play feed 5002 in order to show additional related content 5004.

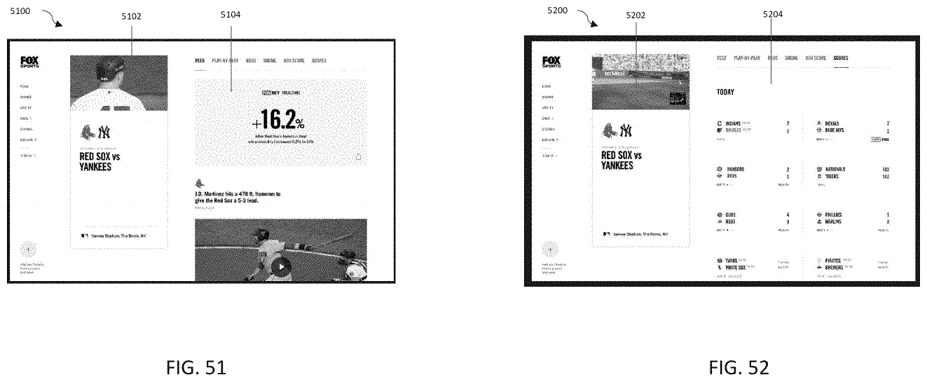

FIG. 51 illustrates another exemplary computing device GUI generally at 5100, illustrating a fully reduced size game play feed 5102 in order to show additional related content 5104.

FIG. 52 illustrates another exemplary computing device GUI generally at 5200, illustrating a fully reduced size game play feed 5202 and a scores section 5204.

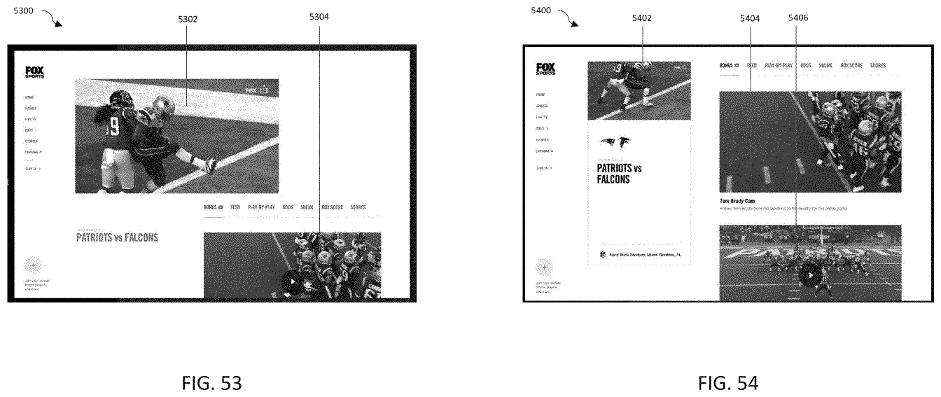

FIG. 53 illustrates another exemplary computing device GUI generally at 5300, illustrating a partially reduced size game play feed 5302 in order to show a Bonus/Bonus camera feed 5304.

FIG. 54 illustrates another exemplary computing device GUI generally at 5400, illustrating a fully reduced size game play feed 5402 in order to show a first 5404 and second 5406 Bonus/Bonus camera feed. As was described above, the bonus camera feeds may play concurrently with the main broadcast/game feed. Additionally, audio may be switched over, as desired.

In exemplary embodiments, a user's television provider account credentials may be utilized to feed authorized media to the website. In further exemplary embodiments, media content is a mixture or assortment of authenticated and unauthenticated media.

In further exemplary embodiments, provided odds are real-time odds generated for particular events or parameters.

FIG. 55 (a)-(e) illustrates a series of functional content within the animated website. In exemplary embodiments, FIG. 55(a) presents as another tile (e.g., a story tile) in a story line, presents after selecting a link, or presents as content embedded within an article (e.g., as content beneath or between article words/paragraphs/etc.). FIG. 55(a) illustrates generally at 5500 functional content as a contest (in this case an embedded FOXBET Super 6 contest, with a further “Play for Free” tab 5502. FIG. 55(b) illustrates a further GUI, shown generally at 5510, that provides one or more selectable options (see selectable options generally at 5512, as well as scroll controls/page indicators generally at 5514 for additional selectables) for “Pick a team to win.” FIG. 55(c) shows a further GUI page generally at 5520 with a pick submission tab 5522. FIG. 55(d) shows another GUI page generally at 5530 for download of a companion app (e.g., allowing download of the FOXBET app for signup or submission of picks from FIG. 55(c). FIG. 55(e) shows another GUI page generally at 5540 presenting selected picks at 55542 and prompting the user to confirm picks at 5544.

We note that the additional content or embedded functional content described above (which may present as separate tiles, within another GUI, such as a story center, or as embedded within an article) can provide various types of information as well as combination of types of information, including without limitation, advertising, links to external content, contests, odds or betting information, etc., and can present in intelligent ways, e.g., showing betting odds and presenting a link to functional betting content while being presented as embedded in an article relevant to the betting odds being displayed.

In exemplary embodiments in line with the above, unified profiles or linked profiles may be provided or enabled where possible between plural platforms (e.g., between the animated website described herein an external betting, contest, etc. platform, if such content is not completely integrated into the animated website's platform). Such features provide higher conversion rates for users, can provide a more seamless user experience and can result in a larger number of user profiles established overall for providing content/promotions/marketing/etc. to those user profiles.

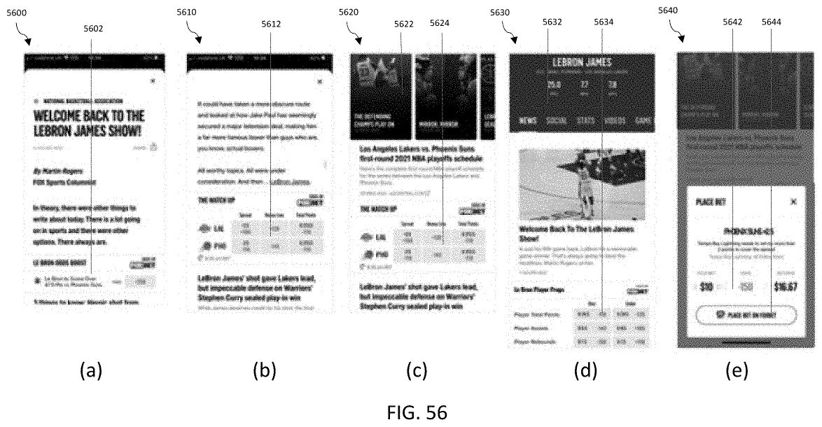

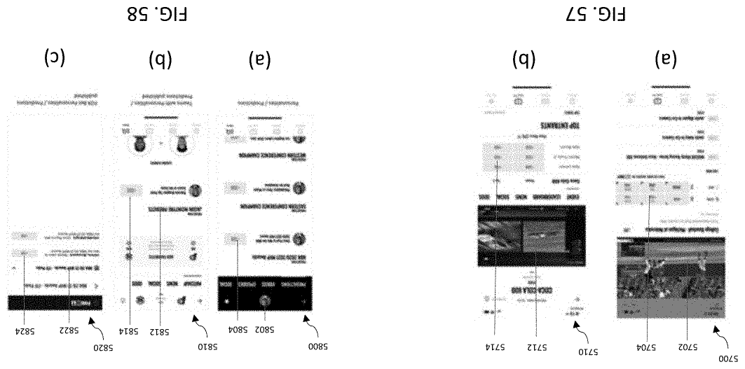

FIGS. 56 (a)-(e) illustrate exemplary animated website GUIs utilizing contextually aware odds, with clickable odds and bet boosts provided as functional content through all content types (e.g., within story tiles, articles, advertisements, promotions, etc.). In exemplary embodiments, content is modified according to the laws of the target audience, e.g., shown with contextually aware odds in non-clickable display form in U.S. states (or areas) that do not allow functional betting within the content, but as clickable content for U.S. states (or areas) where such content is legal. In exemplary embodiments, the user's device location is utilized (e.g., where location services are available to the user's application, browser or operating system, where a user confirms or enters a location, or based upon other information) to determine the functionality of the displayed content. In exemplary embodiments, where such functionality is permitted, a click through of contextually aware odds presents bet slips for betting. Additionally, contextual integration may be based on key terms, phrases, images on the GUI page, a user's profile information, or any other information where context could be derived to present odds or bet boosts for betting or for informational purposes.

FIG. 56(a)-(b) illustrates a first exemplary GUI portion (FIG. 56(a)) generally at 5600 that also includes embedded FOXBET bet boost content 5602. A continuation of the first GUI portion, shown generally at 5610 in FIG. 56(b), illustrates a continuation of the story/article, with exemplary embedded odds/betting content 5612.

FIG. 56(c) shows another exemplary GUI generally at 5620, with tiles 5622 in an upper portion thereof, and with embedded odds content 5624 embedded in a lower portion.

FIG. 56(d) illustrates another exemplary GUI generally at 5630, with content/links, etc. 5632 specific to Lebron James in an upper portion thereof and embedded odds/betting content 5634in a lower portion.

FIG. 56(e) illustrates another exemplary GUI generally at 5640, with a pop-up betting window 5642, generated by clicking embedded content, e.g., from any of FIGS. 56(a)-(d). In exemplary embodiments, the additional content 5642 allows review of odds and/or betting information, and includes an action tab, button, etc. 5644 to submit a bet. In exemplary embodiments in accordance with this embodiment, all prices may become clickable, with the additional content 5642 providing a betslip, which can either place a bet internally or on a linked platform, allow download of an application/signup, or launch an installed application on a betting platform. In exemplary embodiments, the content/user selection is deeplinked between the animated website and the betting platform/server, carrying the user selection across to the betting platform/server.

While certain of the above embodiments describe use of betting/odds/contests or other functionalized content as being provided as a tile or as being embedded, it should be recognized that such content may also be provided as a selectable tab or as part of a menu of selectable items, e.g., as a sportsbook tab or selectable, allowing a new GUI to be presented or allowing modification of a GUI to present such content. Further, any portion of the content may be provided with selectable items, e.g., a score center, with lines or indicates to identify what teams/players/etc. might be a favorite, with presentation of clickable odds, bet boosts, etc., in the score screens, odds sections, game preview sections, live viewing sections, etc.

For example, FIG. 57 (a)-(b) illustrates two exemplary GUIs, shown at 5700 and 5710, respectively that illustrate viewable event feeds 5702, 5712, with clickable/selectable odds/betting/bet boost sections, 5704, 5714.

Another example of integration of functional content includes use of known personality predictions (e.g., a sports commentator/expert/personality) with viewable/selectable betting content, as in FIG. 58 (a)-(c), the GUIs of which are shown generally at 5800, 5810 and 5820. In FIG. 58(a), an identified personality 5802 provides customized information, with associated odds/betting content 5804, which may be clickable/selectable. In FIG. 58(b), personality content is identified at 5812, with exemplary embedded functional (noting again, in general, that such content may be display only in areas/states that do not permit linking to betting, or may be selectable, but restricted from generation of a betslip) content at 5814. In FIG. 58(c), personality information is identified at 5822, with betting content at 5824.

The above-described and other features and benefits of the animated website provide an animated, seamless user experience for live events and otherwise.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

What is claimed is:

1. An animated website GUI, comprising:
a plurality of moving story or article tiles, responsive to swipes or scrolls to browse between a series of stories or articles to open supplemental tiles with further related information.

2. A website GUI in accordance with claim 1, wherein the GUI slides directly from the bottom of a scrolled story or article into another article or into another page of information.

3. An animated website GUI, comprising:
a Live TV window; and
one or more bonus feeds providing video at the same time as the Live TV window, such that plural media windows play concurrently.

4. A website GUI in accordance with claim 3, wherein an audio switch is configured to switch off of the Live TV feed to said one or more bonus feeds.

5. A website GUI in accordance with claim 3, wherein an audio switch is configured to unmute the associated bonus feed and to automatically switch off the audio of all other concurrently playing feeds or videos.

6. A website GUI in accordance with claim 3, wherein the relative sizes of the Live TV feed and the one or more bonus feeds are adjusted by a swiping or scrolling gesture.

7. A website GUI in accordance with claim 1, wherein functionalized content is provided as a moving story or article tile, or is embedded therein.

8. A website GUI in accordance with claim 7, wherein said functionalized content comprises odds or betting content that is linked to a parallel betting platform.

9. An animated mobile computing device GUI, comprising:
in a non-horizontal orientation:
a Live TV window; and
supplemental content related to the Live TV window provided above and/or below said Live TV window; and
in a horizontal orientation:
the Live TV window provided as a full screen, wherein movement of the mobile computing device from a non-horizontal orientation to the horizontal orientation automatically expands the Live TV window to the full screen.

10. The animated mobile computing device GUI of claim 9, wherein a bonus camera icon appears in the horizontal orientation automatically when bonus feeds are available.

11. The animated mobile computing device GUI of claim 10, wherein selection of the bonus camera icon presents one or more bonus feeds next to a reduced size version of the Live TV window.

12. The animated mobile computing device GUI of claim 10, wherein selection of the bonus camera icon presents a carousel of available bonus feeds next to a reduced size version of the Live TV window.

13. The animated mobile computing device GUI of claim 12, wherein vertical swiping of the carousel of available bonus feeds allows selective presentation of the available bonus feeds.

14. The animated mobile computing device GUI of claim 10, wherein selection of an unmute button on one of the available bonus feeds unmutes the audio thereof and automatically mutes the audio of any other feeds playing on the GUI, while at the same time the video of such muted feeds continues to play.

15. The animated mobile computing device GUI of claim 11, wherein the relative sizes of any available bonus feeds and the Live TV window may be adjusted via a swiping gesture.

16. The animated mobile computing device GUI of claim 9, wherein the GUI is automatically configured in the non-horizontal orientation with supplemental options for pre-game, Live TV and post-game browsing of media and content.

17. The animated mobile computing device GUI of claim 9, wherein the GUI presents, in the non-horizontal orientation, a Live TV or featured feed concurrently with at least one additional feed or video media playing video concurrently with the Live TV or featured feed.

18. The animated mobile computing device GUI of claim 9, wherein the GUI presents, in the non-horizontal orientation, a Live TV or featured feed concurrently with plural additional feeds or videos.

19. The animated mobile computing device GUI of claim 18, wherein selection of an unmute button on one of the available additional feeds or videos unmutes the audio thereof and automatically mutes the audio of all other feeds or videos playing on the GUI, while at the same time the video of such muted feeds or videos continues to play.

20. The animated mobile computing device GUI of claim 9, wherein functionalized content is provided as part of said supplemental content, or is embedded therein.

21. The animated mobile computing device GUI of claim 20, wherein said functionalized content comprises odds or betting content that is linked to a parallel betting platform.
